(19) United States
(12) Patent Application Publication
(10) Pub. No.: US 2020/0379443 A1
(43) Pub. Date: Dec. 3, 2020

(54) DATA COLLECTION CHECKING DEVICE OF INDUSTRIAL MACHINE

(71) Applicant: FANUC CORPORATION, Yamanashi (JP)

(72) Inventor: Nao ONOSE, Yamanashi (JP)

(73) Assignee: FANUC CORPORATION, Yamanashi (JP)

(21) Appl. No.: 16/857,667

(22) Filed: Apr. 24, 2020

(30) Foreign Application Priority Data
May 31, 2019 (JP) 2019-102721

(51) Int. Cl. G05B 19/418

(52) U.S. Cl. CPC G05B 19/4183; G05B 19/41865; G05B 19/41885

(57) ABSTRACT

A data collection checking device of an industrial machine includes: a display unit that displays an object indicating the data collecting device and an object indicating the industrial machine; a correlation information acquiring unit that acquires correlation information of data collection between the data collecting device and the industrial machine; an operation determining unit that determines operation of an operator with respect to an object indicating the data collecting device or the industrial machine displayed on the display unit, and identifies the data collecting device or the industrial machine selected by the operator; and a display control unit that displays, on the display unit, an object indicating a correlation between the data collecting device or the industrial machine identified by the operation determining unit and a correlated industrial machine or data collecting device on a basis of the correlation information acquired by the correlation information acquiring unit.

This application is based on and claims the benefit of priority from Japanese Patent Application No. 2019-102721, filed on 31 May, 2019, the content of which is incorporated herein by reference.

### BACKGROUND OF THE INVENTION

### Field of the Invention

The present invention relates to a data collection checking device of an industrial machine.

### Related Art

A data collection system that collects various data of a plurality of industrial machines intensively in a data collecting device is known (e.g., refer to Japanese Unexamined Patent application, Publication No. 2018-173858).

Patent Document 1: Japanese Unexamined Patent Application, Publication No. 2018-173858

### SUMMARY OF THE INVENTION

In the field of data collection of such an industrial machine, it is desirable for the checking of the data collection status as to which industrial machine the data is being collected in which data collecting device to be carried out intuitively and simply.

A data collection checking device of an industrial machine according to the present disclosure is the data collection checking device checking a data collection status when data of the industrial machine are being collected in a data collecting device, and the data collection checking device includes: a display unit that displays an object indicating the data collecting device and an object indicating the industrial machine; a correlation information acquiring unit that acquires correlation information of data collection between the data collecting device and the industrial machine; an operation determining unit that determines operation of an operator with respect to an object indicating the data collecting device or the industrial machine displayed on the display unit, and identifies the data collecting device or the industrial machine selected by the operator; and a display control unit that displays, on the display unit, an object indicating a correlation between the data collecting device or the industrial machine identified by the operation determining unit and a correlated industrial machine or data collecting. device on a basis of the correlation information acquired by the correlation information acquiring unit.

Another data collection checking device of an industrial machine according to the present disclosure is the data collection checking device checking a data collection status when data of the industrial machine are being collected in a data collecting device, and the data collection checking device includes: a display unit that displays augmented reality in which virtual reality is superimposed on the real world, the display unit displaying an object indicating one of the data collecting device and the industrial machine, and displaying the other of the data collecting device and the industrial machine in the real world; a correlation information acquiring unit that acquires correlation information of data collection between the data collecting device and the industrial machine; an operation determining unit that determines operation of an operator with respect to an object indicating the data collecting device or the industrial machine displayed on the display unit, and identifies the data collecting device or the industrial machine selected by the operator; and a display control unit that displays, on the display unit, an object indicating correlation between the data collecting device or the industrial machine identified by the operation determining unit and a correlated industrial machine or data collecting device, on a basis of the correlation information acquired by the correlation information acquiring unit.

According to the present disclosure, in the field of data collection of an industrial machine, it is possible carry out the checking of the data collecting status as to which industrial machine data is collected in which data collecting device intuitively and simply.

### BRIEF DESCRIPTION OF THE DRAWINGS

FIG. 1 is a diagram showing the configuration of a data collection system including a data collection checking device of a machine tool according to a first embodiment;

FIG. 2 is a diagram showing an example of a display by the data collection checking device of the machine tool according to the first embodiment;

FIG. 3 is a diagram showing an example of a display by the data collection checking device of the machine tool according to the first embodiment;

FIG. 4 is a diagram showing an example of a display by the data collection checking device of the machine tool according to the first embodiment;

FIG. 5 is a diagram showing an example of a display by the data collection checking device of the machine tool according to the first embodiment;

FIG. 6 is a diagram showing an example of a display by the data collection checking device of the machine tool according to the first embodiment;

FIG. 7 is a diagram showing a flowchart of data collection. checking operation by the data collection checking device of the machine tool according to the first embodiment;

FIG. 8 is a diagram showing a configuration of a data collection system including a data collection checking device of a machine tool according to a second embodiment;

FIG. 9 is a diagram showing an example of a display by the data collection checking device of the machine tool according to the second embodiment;

FIG. 10 is a diagram showing an example of a display by the data collection checking device of the machine tool according to the second embodiment;

FIG. 11 is a diagram showing an example of a display by the data collection checking device of the machine tool according to the second embodiment; and

FIG. 12 is a diagram showing a flowchart of data collection checking operation by the data collection checking device of the machine tool according to the second embodiment.

### DETAILED DESCRIPTION OF THE INVENTION

Hereinafter, a description will be given of an example of an embodiment of the present invention with reference to the accompanying drawings. It should be noted that the same reference numerals will be given to the same or equivalent parts in the drawings.

### First Embodiment

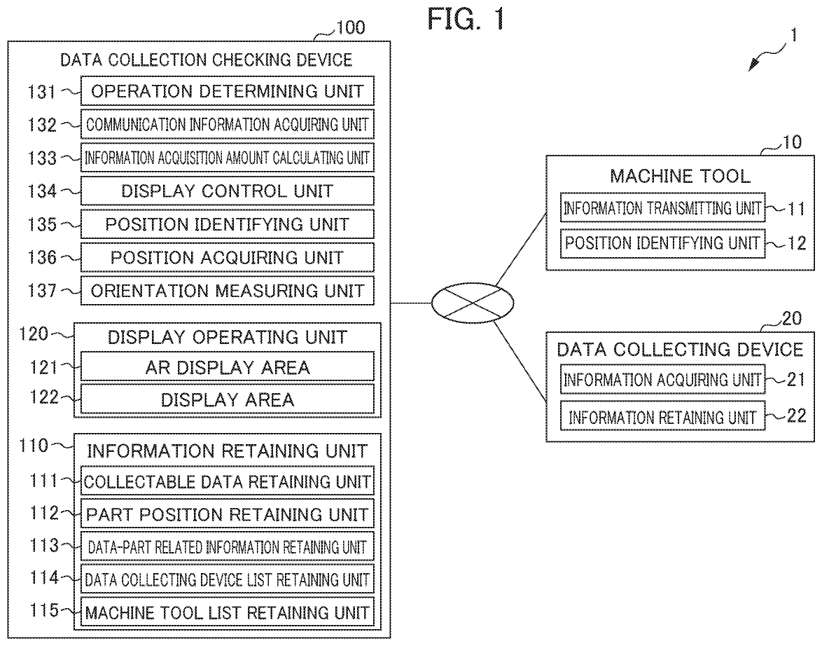

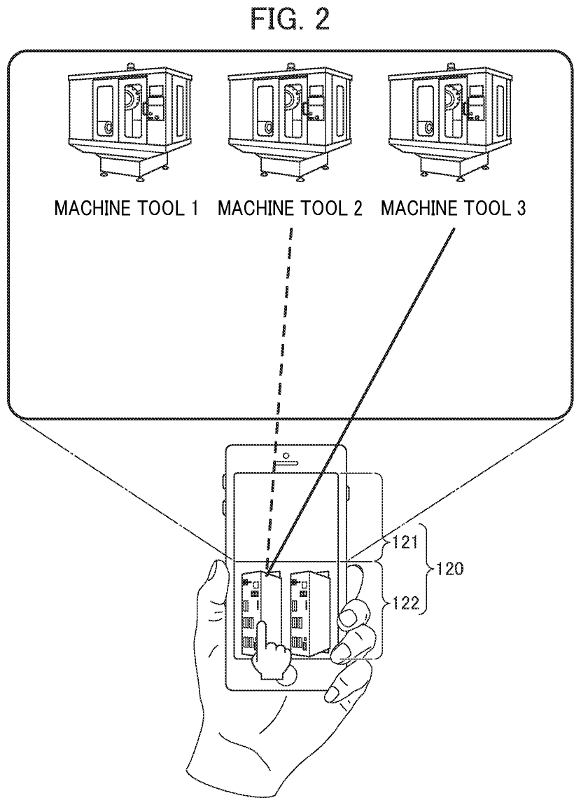

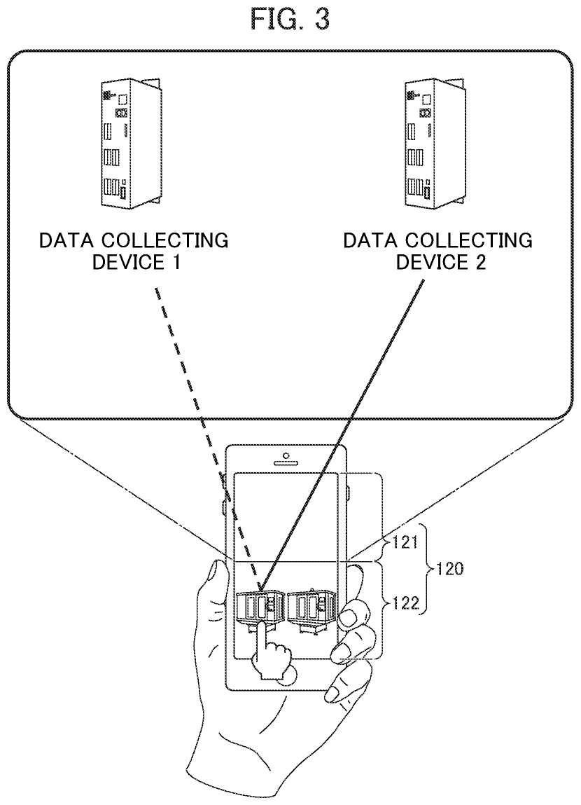

FIG. 1 is a diagram showing a configuration of a data collection system including a data collection checking device of a machine tool according to a first embodiment, and FIG. 2 and FIG. 3 are diagrams each showing an example of a display by the data collection checking device of the machine tool according to the first embodiment. In the data collection system 1 shown in FIG. 1, a plurality of machine tools 10 (only one shown in FIG. 1), a plurality of data collecting devices 20 (only one shown in FIG. 1), and the data collection checking device 100 are connected by a wired or wireless network such as LAN and WAN, or a short-range communication such as Bluetooth and Wi-Fi.

The machine tool 10 is, for example, a device for performing predetermined machining by numerical control. The machine tool 10 includes an information transmitting unit 11 and a position identifying unit 12.

The information transmitting unit 11 transmits various kinds of data-collectable data in the machine tool to a data collecting device 20. Examples of the data-collectable data include temperature of a temperature sensor, data of a vibration sensor, spindle rotation number, control axis rotation number, tool life, numerical control data, circuit information of a programmable logic controller. The position identifying unit 12 retains the position information of the machine tool.

The data collecting device 20 is, for example, a host computer. The data collecting device 20 collects data of the machine tool 10. The data collecting device 20 includes an information acquiring unit 21 and an information retaining unit 22.

The information acquiring unit 21 collects data from the machine tool 10. The information retaining unit 22 retains the data of the machine tool 10 acquired by the information acquiring unit 21.

The data collection checking device 100 checks the data collection status of which machine tool 10 data is collected in which data collecting device 20. The data checking device 100 is, for example, an information processing device such as a smartphone, a tablet, a PC, or the like. The data collection checking device 100 includes the information retaining unit 110, a display operating unit 120, an operation determining unit 131, a communication information acquiring unit 132, an information acquisition amount calculating unit 133, a display control unit 134, the position identifying unit 135, the position acquiring unit 136, and an orientation measuring unit 137.

The data collection checking device 100 (excluding the information retaining unit 110 and the display operating unit 120) is composed of an arithmetic processor such as a DSP (Digital Signal Processor) and an FPGA (Field Programmable Gate Array). The various functions of the data collection checking device 100 (excluding the information retaining unit 110 and the display operating unit 120) are realized by executing predetermined software (program, application) stored in a storage unit, for example. The various functions of the data collection checking device 100 (excluding the information retaining unit 110 and the display operating unit 120) may be realized by cooperation of hardware and software, or may be realized only by hardware (electronic circuit).

The information retaining unit 110 is, for example, rewritable memory such as EEPROM, or a rewritable disk such as an HDD (Hard Disk Drive) or SSD (Solid State Drive). The information retaining unit 110 includes a collectable data retaining unit 111, a part position retaining unit 112, a data-part related information retaining unit 113, a data collecting device list retaining unit 114, and a machine tool list retaining unit 115.

The collectable data retaining unit 111 retains data-collectable data for each machine tool. Examples of the data-collectable data include temperature of the temperature sensor, data of the vibration sensor, the spindle rotation number, the control axis rotation number, the tool life, the numerical control data, and the circuit information of the programmable logic controller.

The part position retaining unit 112 retains the position of the part corresponding to the data-collectable data for each machine tool. Examples of the parts corresponding to the data-collectable data include the temperature sensor, the vibration sensor, various motors, tools, a coolant storage, and IO devices.

The data-part related information retaining unit 113 retains, for each machine tool, the data-part related information in which the data retained by the collectable data retaining unit 111 is associated with the position of the part corresponding to the data-collectable data retained by the part position retaining unit 112.

The data collecting device list retaining unit 114 retains a list of the data collecting devices connected to the network. The list of the data collecting devices includes network identification information, e.g., IP address.

The machine tool list retaining unit 115 retains a list of the machine tools connected to the network. The list of the machine tools includes network identification information, e.g., IP address.

The display operating unit 120 includes a display device such as a liquid crystal display, and includes an AR display area 121 and a display area 122. The display area 122 displays an object indicating one of the data collecting device and the machine tool. The AR display area 121 an area for displaying Augmented Reality (AR) in which virtual reality is superimposed on the real world, and displays by superimposing virtual objects on the other one of the data collecting device and the machine tool in the real world projected by an imaging device such as a camera.

In addition, the display operating unit 120 includes an operation device such as a touch panel, and detects operation by an operator.

The operation determining unit 131 determines the operation of the operator with respect to the object indicating the data collecting device or the machine tool displayed on the display area 122 of the display operating unit 120, and identifies the data collecting device or the machine tool selected by the operator.

The communication information acquiring unit 132 acquires the communication status between the data collecting device and the machine tool. For example, the communication information acquiring unit 132 may acquire by monitoring the communication between the data collecting device 20 and the machine tool 10 irregularly (temporarily, promiscuously), or may acquire from the communication information retained in the data collecting device 20 (for example, the information retaining unit 22).

In this way, the communication information acquiring unit 132 serves as a correlation information. acquiring unit, and acquires the data collection status when various data of the machine tool 10 are being collected in the data collecting device 20, that is, the correlation information of the data collection between the data collecting device and the machine tool. It should be noted that the communication information acquiring unit 132 may acquire the correlation information of the data collection between all of the data collecting devices and the machine tools, or may acquire the correlation information of the data collection of the data collecting device or the machine tool identified by the operation determining unit 131.

The information acquisition amount calculating unit 133 calculates the information acquisition amount from each machine tool for each data collecting device from the communication status acquired by the communication information acquiring unit 132. The data that can be acquired by the data collecting device is determined to have a certain data length for one piece of information. The communication information acquiring unit 132 acquires the mutual communication information (e.g., Duplex and speed), and the information acquisition amount calculating unit 133 calculates the upper limit of the communication amount per time in consideration of the CPU speed of the data collecting device. The information acquisition amount calculating unit 133 calculates, with respect to its upper limit, the percentage of the resources used in a single machine tool, and the calculated result is used as the information acquisition amount.

In this way, the information acquisition amount calculating unit 133 serves as a correlation information acquiring unit, and calculates the amount of data collection from each machine tool for each data collecting device. It should be noted that the information acquisition amount calculating unit 133 may calculate the amount of data collection for each data set in each machine tool.

The display control unit 134 displays, on the AR display area 121, an object indicating the correlation between the data collecting device or the industrial machine, and the industrial machine or the data collecting device having the correlation therewith, on the basis of the communication information (correlation information) acquired by the communication information acquiring unit 132. Furthermore, the display control unit 134 displays, on the AR display area 121, the object indicating the correlation of the data collection in a distinguishable manner in accordance with the data communication amount (the amount of data collection) calculated by the information acquisition amount calculating unit 133.

The position identifying unit 135 identifies the location of the machine tool or the data collecting device in the real world displayed on the AR display area 121, for example, by radio wave intensity positioning of RFID or a beacon provided in the machine tool.

The position acquiring unit 136 acquires the position information of the machine tool from the machine tool 10 (e.g., the position identifying unit 12) acquired by the communication information acquiring unit 132.

The orientation measuring unit 137 measures the orientation of the data collection checking device 100 itself.

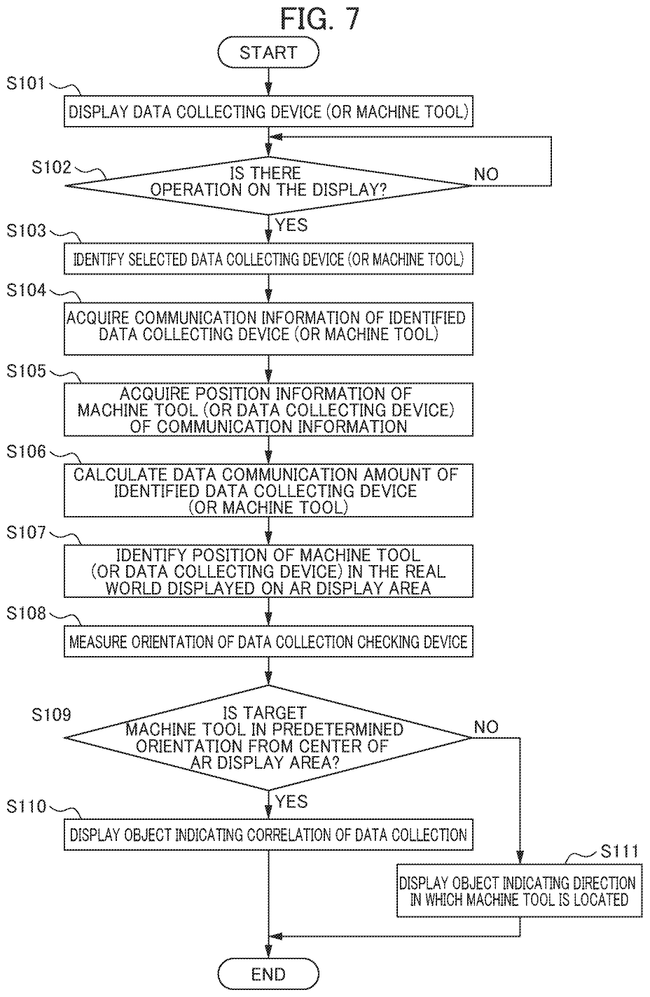

Next, with reference to FIG. 7, a description will be given of data collection checking operation by the data collection checking device of the machine tool according to the first embodiment. FIG. 7 is a flowchart of the data collection checking operation by the data collection checking device of the machine tool according to the first embodiment.

First, the display operating unit 120 displays, on the display area 122, the objects of all the data collecting devices connected to the network on the basis of the list of data collecting devices retained in the data collecting device list retaining unit 114 (refer to FIG. 2) (S101). Alternatively, the display operating unit 120 displays, on the display area 122, the objects of all the machine tools connected to the network on the basis of the list of machine tools retained in the machine tool list retaining unit 115 (refer to FIG. 3) (S101). In the following, the example of FIG. 2 will be described, and the example of FIG. 3 will be described in parentheses.

Next, the operation determining unit 131 determines the operation of the operator with respect to the object of the data collecting device (or the machine tool: FIG. 3) displayed on the display area 122 (S102). If there is no operation by the operator, the processing returns to Step S102.

On the other hand, for example, the operator performs an operation of tapping a desired data collecting device (or a desired machine tool: FIG. 3) displayed on the display area 122. Then, the operation determining unit 131 identifies the data collecting device (or machine tool: FIG. 3) selected by the operator (S103).

Next, the communication information acquiring unit 132 acquires the communication information of the machine tool (or the data collecting device: FIG. 3) from which the data are collected and the communication information such as the data amount (the correlation information of the data collection) from the data collecting device 20 (or the machine tool 10: FIG. 3) identified by the operation determining unit 131 (S104). The identification information of the machine tool (or the data collecting device: FIG. 3) to be acquired may be network identification information such as an. IP address.

Next, the position acquiring unit 136 acquires the position information of the machine tool from the machine tool 10 (e.g., the position identifying unit 12) (or the data collecting device: FIG. 3) acquired by the communication information acquiring unit 132 (3105).

Furthermore, the information acquisition amount calculating unit 133 calculates the data communication amount (the amount of data collection) between the identified data collecting device and each machine tool (or the data communication amount of the identified machine tool and each data collecting device: FIG. 3) on the basis of the data amount acquired by the communication information acquiring unit 132 (106).

Here, the operator displays, on the AR display area 121 of the display operating unit 120, one or a plurality of machine tools (or the data collecting device: FIG. 3) by an imaging device such as a camera. Then, the position identifying unit 135 identifies the location of the machine tool (or the data collecting device: FIG. 3) in the real world displayed on the AR display area 121, for example, by the radio wave intensity positioning of RFID or a beacon provided to the machine tool (or the data collecting device: FIG. 3) (S107).

Furthermore, the orientation measuring unit 137 measures the direction of the data collection checking device 100 itself (S108).

Next, the orientation measuring unit 137 determines whether a target machine tool (or the data collecting device: FIG. 3) is in a predetermined orientation (e.g. ±15 degrees or less) from the center of the AR display area 121 on the basis of an identified orientation, the position of the machine tool (or the data collecting device: FIG. 3) in the real world displayed on the AR display area 121 identified by the position identifying unit 135, and the position of the target machine tool (or the data collecting device: FIG. 3) acquired by the position acquiring unit 136 (S109).

In a case in which the target machine tool (or the data collecting device: FIG. 3) is in a predetermined orientation from the center of the AR display area 121, the target machine tool (or the data collecting device: FIG. 3) is displayed in the AR display area 121. In this case, the display control unit 134 displays, on the AR display area 121, an object (e.g., a correlation line) indicating the correlation of the data collection between the data collecting device 20 and each machine tool 10 (or an object showing the correlation of the data collection between the machine tool 10 and each data collecting device 20: FIG. 3) on the basis of the communication information acquired by the communication information acquiring unit 132 (the correlation information of the data collection). At this time, the display control unit 134 displays the object indicating the correlation of the data collection so as to be distinguished (e.g., in different colors) in accordance with the data communication amount (the amount of data collection) calculated by the information acquisition amount calculating unit 133 (see FIG. 2) (S110).

In the examples of FIGS. 2 and 3, a red correlation line (solid line) is displayed when the amount of data collection is large, and a green correlation line (dotted line) is displayed when the amount of data collection is small. It should be noted that the data collecting device or the machine tool may be placed at the center of the screen, and a correlation line may be displayed in all directions.

On the other hand, if the target machine tool (or the data collecting device: FIG. 3) is not in a predetermined orientation from the center of the AR display area 121, the target machine tool (or the data collecting device: FIG. 3) is not reflected in the AR display area 121. In this case, the display control unit 134 may display, on the AR display area 121, the object indicating the direction in which the target machine tool (or the data collecting device: FIG. 3) is located (Sill). Thus, the operator can perform correction so that the target machine tool (or the data collecting device: FIG. 3) is displayed on the AR display area 121.

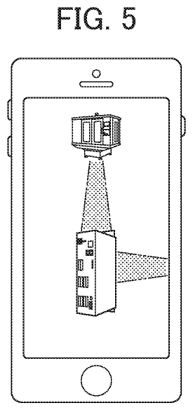

For example, as shown in FIG. 5, a correlation line may be displayed which extends from the lower portion of the display area (approximately 100 cm from the ground) to the machine tool, or a correlation line may be acceptable in which the depth is determined according to the distance to the machine tool. Alternatively, a correlation line may be displayed only when the display area is directed to the machine tool, or an arrow may be displayed until the display area is directed to the machine tool. Alternatively, a correlation line may be displayed only in the direction in which 30% of the virtual object of the machine tool is displayed, or a correlation line may be displayed which extends in a direction in which the machine tool is located while the data collecting device is placed near the center.

Furthermore, in the example of FIG. 2, in a case in which the machine tool in the real world displayed on the AR display area 121 is tapped in place of the object of the data collecting device displayed on the display area 122, the object indicating the correlation of the data collection may be displayed. Similarly, in the example of FIG. 3, in a case in which the data collecting device in the real world displayed on the AR display area 121 is tapped in place of the object of the machine tool displayed on the display area 122, the object indicating the correlation of the data collection may be displayed.

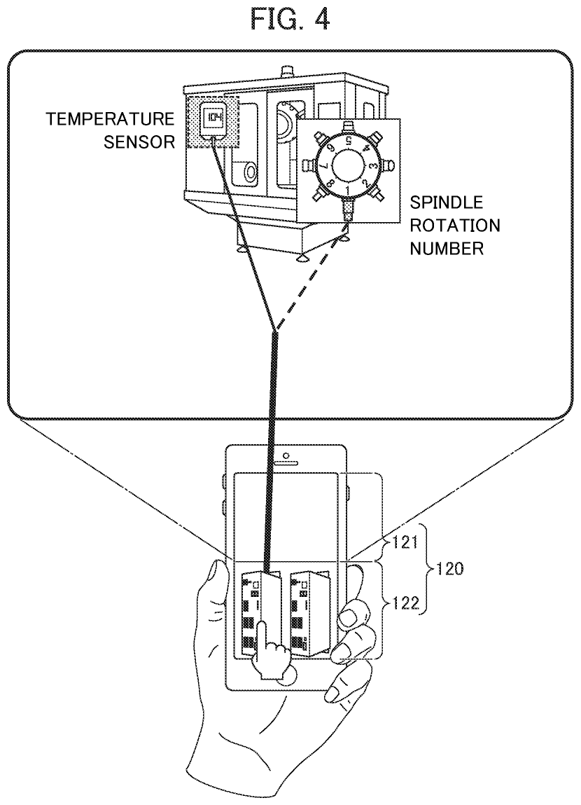

Furthermore, as shown in FIG. 4, the display control unit 134 may display, on the AR display area 121, a virtual object relating to the data-collectable data in the machine tool displayed on the AR display area 121, for example, at the position of the parts corresponding to the data-collectable data. Furthermore, the display control unit 134 may display, on the AR display area 121, a virtual object relating to a part corresponding to the data-collectable data.

In this case, the display control unit 134 may cause the correlation line to be branched for each data set or part of the machine tool. In the example of FIG. 4, a thick line extends according to the amount of the data collection from the data collecting device to an identifying unit of the machine tool, and a thin line extends according to the amount of the data collection from the branch point to the data set or part.

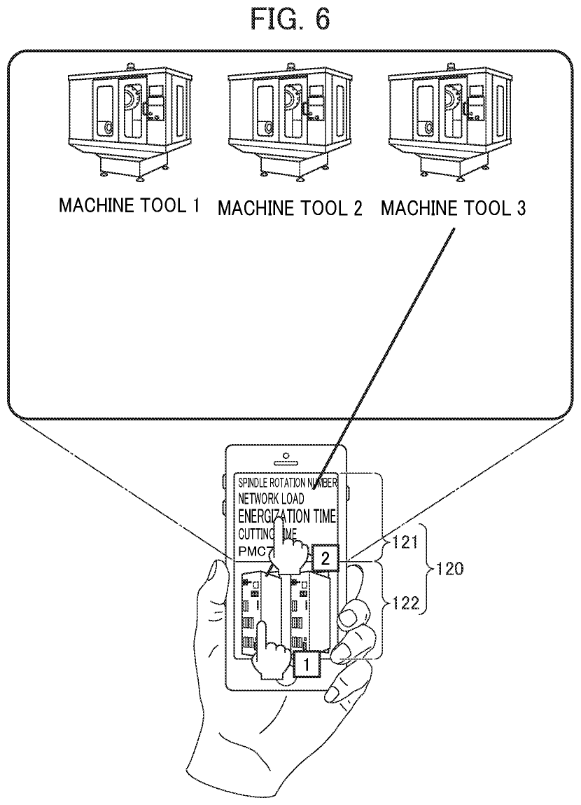

Furthermore, as shown in FIG. 6, the display control unit 134 may display options of the data collection on the AR display area 121. In this case, the display control unit 134 may display, on the AR display area 121, an object relating to the correlation of the data collection of the data selected by the operator.

As described above, the data collection checking device 100 of the machine tool according to the first embodiment performs the following processing:
acquire correlation information of data collection between data collecting device and industrial machine,
determine the operation of the operator with respect to the object indicating the data collecting device (or the industrial machine) displayed on the display unit to identify the data collecting device (or the industrial machine) selected by the operator, and
based on the acquired correlation information, display an object indicating the correlation between the identified data collecting device (or the industrial machine) and the correlated industrial machine (or the data collecting device). Thus, for example, it is possible for the operator to check the data collection status of which machine tool data is collected in which data collecting device, by simply performing intuitive and simple operations such as selecting a desired data collecting device (or an industrial machine) displayed on the display unit.

Here, the data collecting device has a limitation in terms of the amount of information that can be collected. According. to the data collection checking device 100 of the machine tool of the first embodiment, the operator can check the free space of the data collecting device.

Furthermore, for example, if the purpose is to collect data in relation to the life, it is preferable to collect the data relating to the use environment such as the operating rotation speed and the environmental temperature of the tool in the same data collecting device. According to the data collection checking device 100 of the machine tool of the first embodiment, the operator can check whether the data to be summarized can be aggregated in a specific data collecting device.

Furthermore, according to the data checking device 100 of the machine tool of the first embodiment, it is possible to serve to prevent an incident such as a case in which an incorrect data collecting device has been designated by mistake when the operator would have desired to cause it to perform the data collection between a specific machine tool and a specific data collecting device from the viewpoint of noise or the like.

### Second Embodiment

In the first embodiment, the data collection checking device includes the AR function. On the other hand, in the second embodiment, the data collection checking device does not include the AR function.

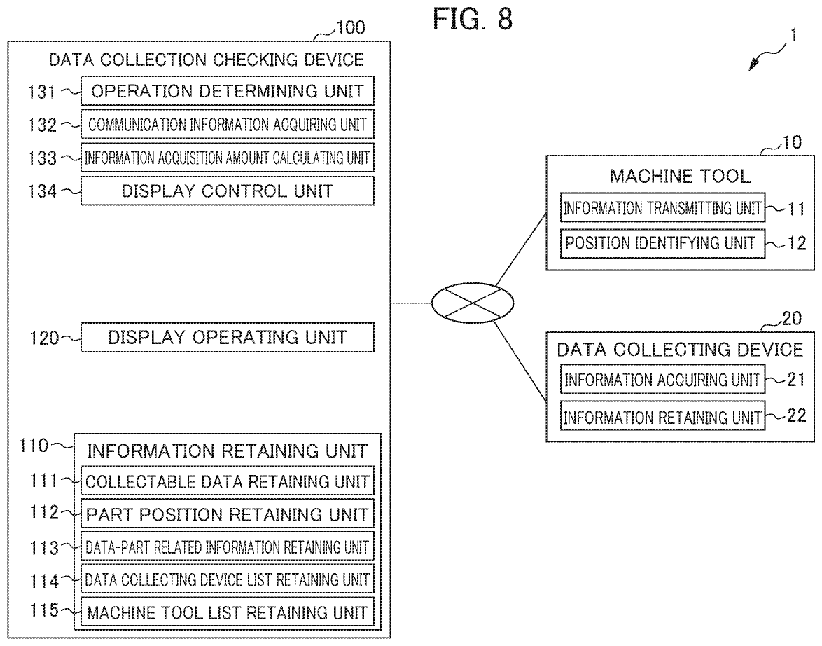

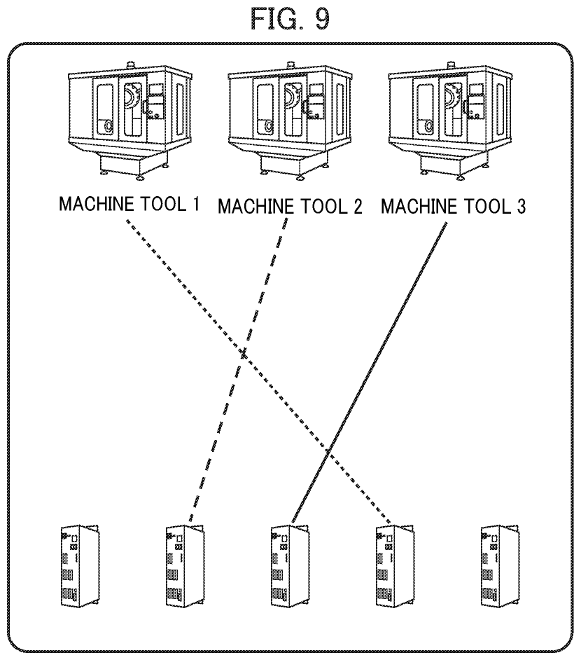

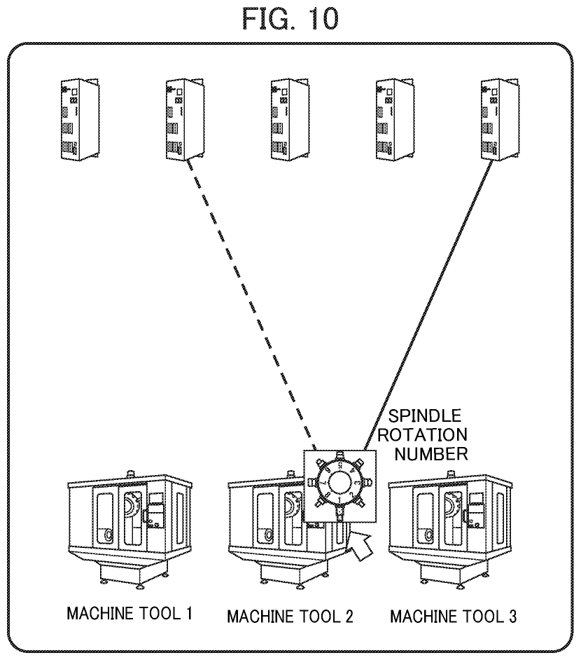

FIG. 8 is a diagram showing a configuration of a data collection system including a data collection checking device of a machine tool according to a second embodiment. FIG. 9 and FIG. 10 are diagrams each showing an example of display by the data collection checking device of the machine tool according to the second embodiment. The data collection checking device 100 shown in FIG. 8 differs from the data collection checking device 100 shown in FIG. 1 in that the display operating units 120 are different from each other, and the former does not include the position identifying unit 135, the position acquiring unit 136 or the orientation measuring unit 137.

The display operating unit 120 includes a display device, for example, for displaying a WEB screen. The display operating unit 120 displays an object indicating a data collecting device connected to a network on the basis of a list of data collecting devices retained in a data collecting device list retaining unit 114. In addition, the display operating unit 120 displays an object indicating a machine tool connected to the network on the basis of a list of machine tools retained in a machine tool list retaining unit 115.

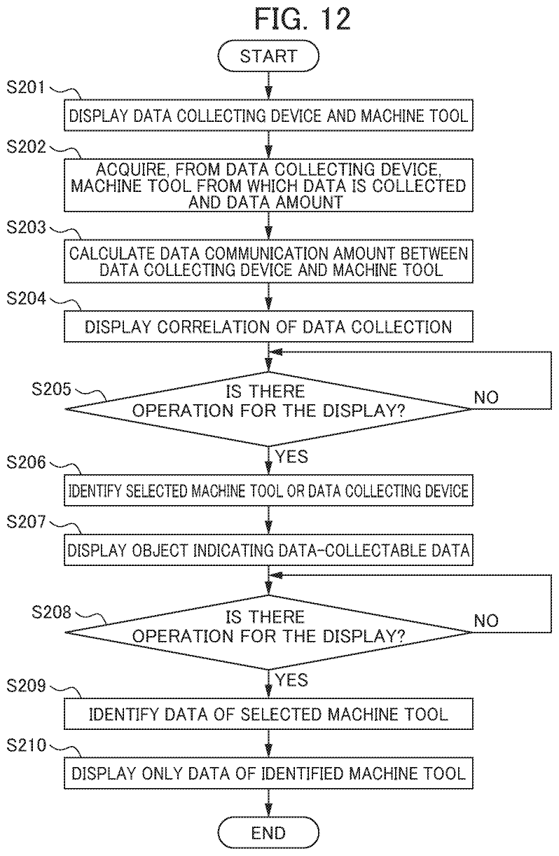

Next, with reference to FIG. 12, a description will be given of data collection. checking operation by the data collection checking device of the machine tool according to the second embodiment. FIG. 12 is a flowchart of data collection checking operation by the data collection checking device of the machine tool according to the second embodiment.

First, the display operating unit 120 displays the objects of all the data collecting devices connected to the network on the basis of the list of data collecting devices retained in the data collecting device list retaining unit 114. Furthermore, the display operating unit 120 displays the objects of all the machine tools connected to the network on the basis of the list of machine tools retained in the machine tool list retaining unit 115 (S201).

Next, the communication information acquiring unit 132 acquires, from all the data collecting devices 20, the communication information of machine tools from which the data are collected and the communication information such as the data amount (the correlation information of the data collection) (3202).

Next, the information acquisition amount calculating unit 133 calculates the data communication amount (the amount of data collection) between each data collecting device 20 and each machine tool 10 on the basis of the data amount acquired by the communication information acquiring unit 132 (S203).

Next, the display control unit 134 displays, on the display operating unit 120, an object (e.g., a correlation line) indicating the correlation of the data collection between each data collecting device 20 and each machine tool 10 on the basis of the communication information (the correlation information of the data collection) acquired by the communication information acquiring unit 132. At this time, the display control unit 134 displays the object indicating the correlation of the data collection in a distinguishable manner (e.g., in different colors) in accordance with the data communication amount (the amount of data collection) calculated by the information acquisition amount calculating unit 133 (see FIG. 2) (S204).

Next, the operation determining unit 131 determines the operation of the operator with respect to the object of a desired machine tool (or a desired data collecting device) displayed in the display operating unit 120 (S205). If there is no operation by the operator, the processing returns to Step S205.

On the other hand, for example, the operator performs an operation of tapping an object of a desired machine tool (or a desired data collecting device) displayed on the display operating unit 120. Then, the operation determining unit 131 identifies the machine tool (or the desired data collecting device) selected by the operator (S206).

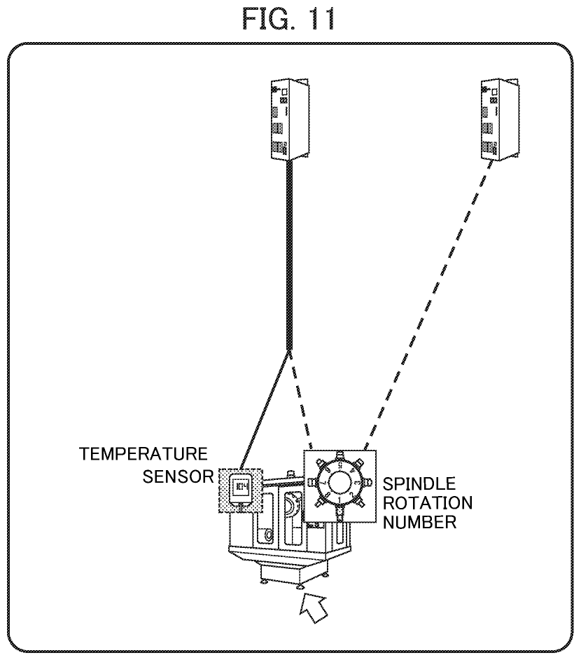

At this time, the display operating unit 120 may display only the object (the correlation line) relating to the correlation of the data collection of the identified machine tool (or the desired data collecting device), and the machine tool and the data collecting device (refer to FIG. 11). According to this, the correlation of the data collection of the identified machine tool (or the desired data collecting device) can be made intuitively recognizable by the operator.

Next, the display control unit 134 displays, on the display operating unit 120, a virtual object relating to the data-collectable data in the identified machine tool or a virtual object relating to a part corresponding to the data-collectable data (refer to FIG. 10) on the basis of the data collectable data retained in the collectable data retaining unit 111, the position of a part corresponding to the data-collectable data retained in the part position retaining unit 112, and the data-part relation information retained in the data-part related information retaining unit 113 (S207).

Next, the operation determining unit 131 determines the operation of the operator with respect to the object of the desired data or part displayed on the display operating unit 120 (S208). If there is no operation by the operator, the processing returns to Step S208.

On the other hand, for example, the operator performs an operation of tapping the virtual object relating to the desired data or part displayed on the display operating unit 120. Then, the operation determining unit 131 identifies the data of the machine tool selected by the operator (S209).

At this time, the display operating unit 120 may display only the object (the correlation line) relating to the correlation of the data collection of the identified machine tool (or the desired data collecting device), and the machine tool and the data collecting device (refer to FIG. 11) (S210). According to this, the correlation of the data collection of the identified machine tool (or the desired data collecting device) can be made intuitively recognizable by the operator.

As described above, even in the data collection checking device 100 of the machine tool of the second embodiment, it is possible to obtain the same advantages as the data collection checking device 100 of the machine tool of the first embodiment.

Although the embodiments of the present invention have been described above, the present invention is not limited to the embodiments described above, and various modifications and variations are possible. For example, in the above-described embodiment, a data collection checking device for checking the data collection status when the data of the machine tool is being collected in the data collecting device is exemplified; however, the present embodiment is not limited thereto. The data collection checking device of the present embodiment is applicable to various devices for checking the data collection status when collecting data of various industrial machines in the data collecting device.

### EXPLANATION OF REFERENCE NUMERALS

1 data collection system
10 machine tool
11 information transmitting unit
12 position identifying unit
20 data collecting device
21 information acquiring unit
22 information retaining unit
100 data collection checking device
110 information retaining unit
111 collectable data retaining unit
112 part position retaining unit
113 data-part related information retaining. unit
114 data collecting device list retaining unit
115 machine tool list retaining unit
120 display operating unit
121 AR display area
122 display. area
131 operation determining unit
132 communication information acquiring unit
133 information acquisition amount calculating unit
134 display control unit
135 position identifying. unit
136 position acquiring unit
137 orientation measuring unit

What is claimed is:

1. A data collection checking device of an industrial machine, the data collection checking device checking a data collection status when data of the industrial machine are being collected in a data collecting device, the data collection checking device comprising:
a display unit that displays an. object indicating the data collecting device and an object indicating the industrial machine;
a correlation information acquiring unit that acquires correlation information of data collection between the data collecting device and the industrial machine;
an operation determining unit that determines operation of an operator with respect to an object indicating the data collecting device or the industrial machine displayed. on the display unit, and identifies the data collecting device or the industrial machine selected by the operator; and
a display control unit that displays, on the display unit, as object indicating a correlation between. the data collecting device or the industrial machine identified by the operation. determining unit and a correlated industrial machine or data collecting device on a basis of the correlation information acquired by the correlation information acquiring unit.

2. A data collection checking device of an industrial machine, the data collection checking device checking a data collection status when data of the industrial machine are being collected in a data. collecting device, the data collection checking device comprising:
a display unit that di splays augmented reality in which virtual reality is superimposed on the real world, the display unit displaying an object. indicating one of the data collecting device and the industrial machine, and displaying the other of the data collecting device and. the industrial machine in the real world;
a correlation. information acquiring unit that acquires correlation information of data collection between the data collecting device and the industrial machine;
an operation determining unit that determines operation of an operator with respect to an object indicating the data collecting device or the industrial machine displayed on the display unit, and identifies the data collecting device or the industrial machine selected by the operator; and
a display control unit that displays, on the display unit, an object indicating correlation between the data collecting device or the industrial machine identified by the operation determining unit and. a correlated industrial machine or data collecting device, on a basis of the correlation information acquired by the correlation. information acquiring unit..

3. The data collection checking device of the industrial machine according to claim 1, wherein the correlation information acquired by the correlation information acquiring unit includes an amount of data collection, and
the display control unit displays, on the display unit, an object indicating the correlation in a distinguishable manner in accordance with the amount of data collection.

4. The data collection checking device of the industrial machine according to claim 1, wherein the object indicating the correlation is a correlation line, and
the correlation line is branched for each data of the industrial machine.

5. The data collection checking device of the industrial machine according to claim 2, wherein, in a case in which a correlated industrial machine or data collecting device in the real world falls outside a display area of the display unit, the display control unit displays, on the display unit, an object indicating a direction in which the correlated industrial machine or data collecting device in the real world is located.

6. The data collection checking device of the industrial machine according to claim 1, wherein the display control unit displays, on the display unit, only an object indicating correlation between the data collecting device or the industrial machine identified by the operation determining unit and a correlated. industrial machine or data collecting device.

7. The data collection checking device of the industrial machine according to claim 1, wherein the display control unit displays, on the display unit, options of data collected in the data collecting device or the industrial machine identified by the operation determining unit, and displays, on the display unit, an object indicating correlation of data collection of data selected by the operator.

8. The data collection checking device of the industrial machine according to claim 2, wherein the correlation information acquired by the correlation information acquiring unit includes an amount of data collection, and
the display control unit displays, on the display unit, an object indicating the correlation in a distinguishable manner in accordance with the amount of data collection.

9. The data collection checking device of the industrial machine according to claim 2, wherein the object indicating the correlation is a correlation line, and
the correlation line is branched for each data of the industrial machine.

10. The data collection checking device of the industrial machine according to claim 2, wherein the display control unit displays, on the display unit, options of data collected in the data collecting device or the industrial machine identified by the operation determining unit, and displays, on the display unit, an object indicating correlation of data collection of data selected by the operator.
